(19) United States
(12) Patent Application Publication
(10) Pub. No.: US 2023/0343969 A1
(43) Pub. Date: Oct. 26, 2023

(54) ELECTRODES FOR FUEL CELLS AND ELECTROLYZERS

(71) Applicant: UNIVERSITY OF SOUTH CAROLINA, COLUMBIA, SC (US)

(72) Inventors: WILLIAM MUSTAIN, BLYTHEWOOD, SC (US); NOOR UL HASSAN, COLUMBIA, SC (US)

(21) Appl. No.: 18/300,533

(22) Filed: Apr. 14, 2023

Related U.S. Application Data
(60) Provisional application No. 63/333,393, filed on Apr. 21, 2022.

(51) Int. Cl. H01M 4/86; H01M 4/88; C25B 1/04; C25B 11/095

(52) U.S. Cl. CPC H01M 4/8668; H01M 4/8828; H01M 4/8673; C25B 1/04; C25B 11/095; H01M 2008/1095

(57) ABSTRACT

Electrodes for use in electrochemical cells are described. The electrodes incorporate ionomers in multiple different particulate forms, including at least one larger particle form and at least one smaller particle form. The electrodes include electrode active particles, and optionally, can also include additional binder particles or other additives. The electrodes can be used in fuel cells or electrolyzers, including hydrogen fuel cells and water electrolyzers.

### CROSS REFERENCE TO RELATED APPLICATION

This application claims filing benefit of U.S. Provisional Patent Application Ser. No. 63/333,393 having a filing date of Apr. 21, 2022, which is incorporated herein by reference for all purposes.

### BACKGROUND

Electrochemical cells can be utilized to generate useful electrical energy from chemical reactions, or alternatively, to facilitate desired chemical reactions by use of electrical energy. While utilized for many years in a variety of applications, electrochemical cells have garnered great interest more recently for their potential of decreasing reliance on fossil fuels through both generation and storage of energy derived from renewable resources. For instance, hydrogen is an excellent fuel for electron generation in hydrogen fuel cells and it can be generated via electrolysis using electrochemical cells that can be powered by renewable energy sources.

Whether utilized to generate electrical energy or to promote a chemical reaction, electrochemical cells include first and second electrodes at which the respective cell half-reactions take place, a path for ions generated or utilized in the half-reactions, and a path for electrons generated or utilized in the half-reactions. In low-temperature electrochemical cells, the electrodes in turn include high surface area active materials that are typically in the form of particles retained by use of a polymeric binder so as to be in electrical communication with an electric circuit as well as in ionic communication with the electrolyte. Typically, a single polymeric material is utilized to enable both binding and ionic conductivity. Unfortunately, because that single material must provide the function of retaining the electrode active materials in place under the harsh operating conditions of the cell as well as the function of ion transport, the ion transport through the electrodes is often less than ideal. In some cases, a non-ionic polymer additive is incorporated to provide binding or to manipulate hydrophobicity, but such an inclusion does not facilitate enhanced ionic conductivity.

What are needed in the art are electrode materials that can provide both excellent binding functionality and efficient ionic transport through the electrode.

### SUMMARY

According to one embodiment, disclosed is an electrode comprising first polymeric particles, second polymeric particles, and electrode active particles. The first polymeric particles have a cross-sectional dimension of from about 5 micrometers to about 50 micrometers. In addition, the first polymeric particles include a first ionomer. The second polymeric particles have a cross-sectional dimension that is less than that of the first polymeric particles. For instance, the second polymeric particles can have a cross-sectional dimension that is about 1 micrometer or less, e.g., on the nanometer scale. The second polymeric particles can include a second ionomer, which can be the same or different as the first ionomer. The electrode active particles are in ionic communication with the first and second polymeric particles

Also disclosed is an electrochemical cell including an anode, a cathode, and an electrolyte separating the anode and the cathode, with at least one of the anode and cathode being an electrode as disclosed herein. The electrodes are in ionic communication with the electrolyte and are configured for electrical communication with an electric circuit. In one embodiment, an electrochemical cell can include a polymer electrolyte membrane (PEM) separating the anode and cathode. An electrochemical cell can include a current collector on a second side of each of the electrodes. Electrochemical cells can include other components as known in the art such as one or more gas diffusion layers, inlet and outlet flow channels, etc.

An electrochemical cell can be a fuel cell or an electrolyzer cell. For instance, an electrochemical cell can be a hydrogen fuel cell, e.g., a proton exchange membrane fuel cell or an anion exchange membrane fuel cell, that can incorporate an electrode as disclosed at the cathode, the anode, or both. In some embodiments, an electrochemical cell can be an electrolyzer cell, e.g., a proton exchange membrane electrolyzer, an anion exchange membrane electrolyzer, an alkaline electrolyzer, etc. An electrolyzer can be designed to produce hydrogen via water electrolysis, carbon-containing chemicals from carbon dioxide, etc.

Also disclosed are methods for forming the electrodes. For instance, a method can include combining first larger ionomer polymeric particles, second smaller ionomer polymeric particles, and electrode active particles with a liquid to form a slurry, applying the slurry to the surface of an electrochemical cell (e.g., a gas diffusion layer, a current collector, etc.), and then removing the solvent from the slurry to form the electrode.

### BRIEF DESCRIPTION OF THE FIGURES

A full and enabling disclosure of the present subject matter, including the best mode thereof to one of ordinary skill in the art, is set forth more particularly in the remainder of the specification, including reference to the accompanying figures in which:

FIG. 1 is a schematic representation of one embodiment of an electrode as described herein.

FIG. 2 is a schematic representation of another embodiment of an electrode as described herein.

FIG. 3 illustrates one embodiment of an electrochemical cell as may incorporate an electrode as described herein.

FIG. 4 illustrates a proton exchange PEM fuel cell as may incorporate an electrode as described herein.

FIG. 5 illustrates an anion exchange PEM fuel cell as may incorporate an electrode as described herein.

FIG. 6 illustrates a proton exchange PEM electrolyzer cell as may incorporate an electrode as described herein.

FIG. 7 Illustrates an anion exchange PEM electrolyzer cell as may incorporate an electrode as described herein.

FIG. 8 illustrates an alkaline electrolyzer cell as may incorporate an electrode as described herein.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to electrodes for use in electrochemical cells. The electrodes incorporate ionomers in multiple different particulate forms, including at least one larger particle form and at least one smaller particle form. The larger ionomer particle allows for efficient long-range ion transport in the electrode (e.g., on the order of micrometers), while the smaller ionomer particle allows for efficient short-range ion transport of ions in the electrode, and in particular, efficient ion conductions between the larger particles and the active electrode particles. As such, the electrodes can exhibit improved ionic transport as compared to previously known electrodes and effectively increase the electrochemical active area. The improved electrochemical active area of disclosed electrodes can allow electrochemical cells that incorporate the electrodes to achieve high operating currents and high efficiencies.

In addition to providing excellent ionic transport, disclosed electrodes can also provide excellent binding functionality to the electrodes. The multiple different sizes of particles of the electrode can provide increased surface area of interaction between the various components of the electrode, which can improve binding between the components. Moreover, in some embodiments, disclosed electrodes can include additional binding components, e.g., polymers that can provide binding functionality without also necessarily offering ionic transport. The addition of a component having a primary binding functionality can further improve the binding characteristics of the materials, which can further increase the active lifetime of electrochemical cells that incorporate the electrodes.

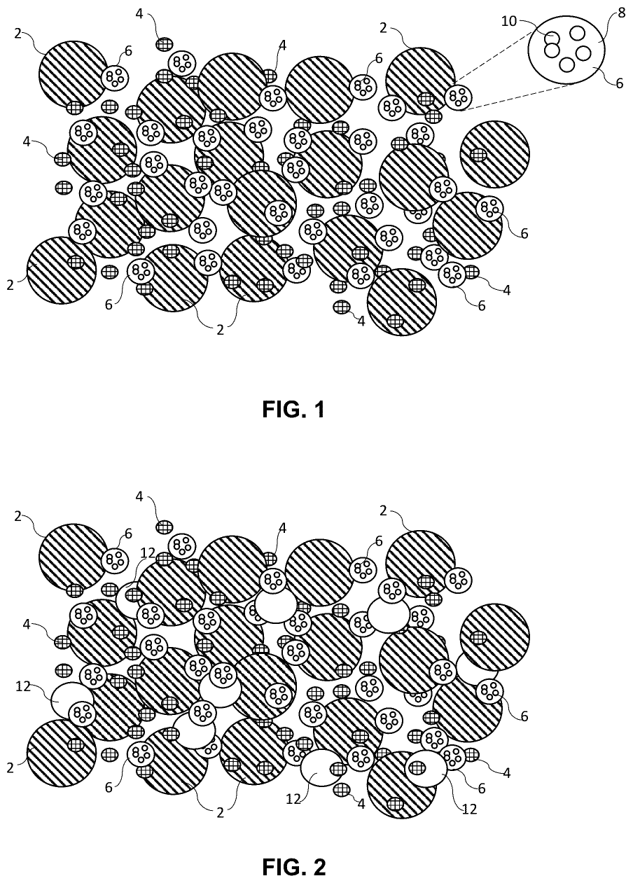

FIG. 1 schematically illustrates one embodiment of an electrode as disclosed herein. The electrode generally includes relatively large polymeric particles 2 that include at least one ionomer, as well as relatively small polymeric particles 4 that also include at least one ionomer.

The large polymeric particles 2 can generally have an average size of from about 5 micrometers to about 50 micrometers, such as from about 10 micrometers to about 40 micrometers, from about 15 micrometers to about 35 micrometers, or from about 20 micrometers to about 30 micrometers, in some embodiments. While the large polymeric particles can have a narrow size distribution in some embodiments, this is not a requirement of the electrodes.

The small polymeric particles 4 can have an average size that is less than that of the large particles 2. In general, the small particles 4 can be sub-micron in size, i.e., having an average size of about 1 micrometer or less. For instance, the small particles 4 can have an average size of from about 10 nanometers to about 1 micrometer, from about 20 nanometers to about 800 nanometers, or from about 100 nanometers to about 500 nanometers, in some embodiments.

While illustrated in FIG. 1 as generally spherical, it should be understood that the polymeric particles 2, 4 can be of any shape including, without limitation, spherical, cubic, pyramidal, rod-shaped, amorphous, etc.

Both of the polymeric particles 2, 4 include at least one ionomer. The preferred ionomer(s) of the particles can generally depend upon the type of electrode (cathode or anode) as well as on the particular application of the electrochemical cell incorporating the electrode (hydrogen fuel cell, water electrolysis, etc.). Ionomers encompassed herein can include any polymer capable of conducting ions. In general, the ionomer(s) can include copolymers including ionized monomer units, which can generally be present on groups pendant to the copolymer backbone.

Ionomers of the particles 2, 4 can include a variety of backbone components, including, without limitation, non-fluorinated, partially fluorinated, or fully fluorinated polymers, such as polyethylenes, polybutylenes, polysulfones, polyphenylene oxides (PPO), polyphenylenes, polybenzimidazoles (PBI), polynorbornenes (PNB), polystyrenes, polymethacrylates, and poly(ethylene-co-tetrafluoroethylene) (ETFE). In some embodiments, an ionomer of the particles 2, 4 can include a perfluorinated sulfonic-acid (PFSA) ionomer, such as available under the Nafion® brand from DuPont™. Hydrocarbon-based ionomers can be utilized in some embodiments, examples of which can include, without limitation, sulfonated poly(arylene ether sulfone), sulfonated poly(arylene ether ketone), sulfonated poly(arylene ether nitrile), sulfonated polyphenylene and sulfonated polyimide. In some embodiments, covalently-linked side-chain quaternary ammonium cationic groups can be incorporated on the copolymers for conduction of anions (e.g., OH⁻), while covalently-linked side-chain carboxyl anionic groups can be incorporated on the copolymers for conduction of cations (e.g., H⁺).

In some embodiments, the polymeric particles 2, 4 can include additional components as known in the art, in addition to the one or more ionomers, e.g., cross-linkers, plasticizers, etc. In some embodiments, the polymeric particles 2, 4 can include only the ionomers, with no additional components.

The large polymeric particles 2 and the small polymeric particles 4 can both include the same ionomer in some embodiments. For instance, in some embodiments, the small polymeric particles 4 can be formed by size reduction (e.g., grinding, cryogenic size reduction, etc.) of a portion of the large polymeric particles 2. However, in other embodiments, the materials of the large and small particles can differ. For instance, both can include one type of an ionomer in common (e.g., a PFSA-based ionomer), while either the larger or smaller particles can include one or more additional ionomers (e.g., PNB-based ionomer) in conjunction with the first ionomer. In other embodiments, the large and small particles can include different ionomers all together.

In general, an electrode can include the ionomer particles in an amount of from about 10 wt. % to about 40 wt. % of the total electrode, such as from about 15 wt. % to about 30 wt. %, or from about 15 wt. % to about 25 wt. %, in some embodiments. The relative amounts of the large and small particles are not particularly limited. For instance, the weight ratio of large particles to small particles can be from about 1:10 to 10:1, such as from about 1:5 to about 5:1, or from about 1:3 to 3:1, in some embodiments.

Referring again to FIG. 1, in addition to the large particles 2 and the small particles 4, the electrode can include electrode active particles 6. The electrode active particles 6 can provide both catalyst functionality to the half-reaction that takes place at the electrode, as well as the electrical conductivity between the electrode and external circuitry.

As indicated in the expanded view of a single electrode active particle 6 of FIG. 1, in this particular embodiment, the electrode active particles 6 can be composite materials that can include a carrier particle 8 (e.g., carbon) that can generally have a size of from about 2 to about 100 nanometers, and smaller, high surface area catalyst particles 10 (e.g., platinum) that can generally have a size of from about 1 to about 10 nanometers adhered on the surface of the larger carrier particle 8. Such electrode active particles 6 are generally known in the art, for instance, the catalyst particles can include one or more metals selected from Au, Ag, Pd, Pt, Rh, Cu, Fe, Ni, Co, Sn, Ti, In, Al, Ta, Sb, Ru, Mo and Cr, and the carrier particles comprise carbon or other suitable carrier material. However, it should be understood that this particular embodiment is not a requirement of the electrode active particles 6, and any electrode active particles as known in the art are encompassed herein including single material particles and single or multiple material catalyst particles absent a carrier.

Preferred materials for the electrode active particles 6 can generally depend upon the type of electrode (cathode or anode), as well as upon the application of the electrochemical cell (fuel cell or electrolyzer). In those embodiments in which the electrode active particle includes two or more kinds of metals, the metals may be an alloy in the form of a solid solution, a eutectic crystal not in the form of solid solution, or a mixture of an alloy and a eutectic crystal.

Representative cathode active particle materials can include, without limitation, platinum (Pt), nickel on cerium oxide (Ni/CeO₂), lanthanum oxide on carbon (La₂O₃/C), nickel-molybdenum (Ni-Mo), platinum-nickel (Pt-Ni), platinum-cobalt (Pt-Co), platinum-copper (Pt-Cu), platinum-iron (Pt-Fe), platinum-palladium (Pt-Pd), nickel (Ni), platinum on titanium (Pt/Ti), nickel-cerium oxide-lanthanum oxide-carbon composites (Ni/(CeO₂-La₂O₃)/C), nickel iron cobalt (NiFeCo), nickel aluminum molybdenum (NiAlMo), etc., as well as combinations of catalysts.

Representative anode active particle materials can include, without limitation, lead ruthenium oxides (Pb₂Ru₂Oₓ), iridium oxide (IrO₂), copper cobalt oxides (CuCoOₓ, CuCoO₃) (optionally, on a carrier such as nickel foam), nickel-iron (NiFe), NiCoOₓ on Fe, Ni, Cu_{0.7}CO_{2.3}O₄, Ce_{0.2}MnFe_{1.8}O₄, NiCo₂O₄ (optionally, on a carrier such as steel mesh), CuₓCo₃₋ₓO₄, NiFe₂O₄, NiAl, Pt, platinum-ruthenium (Pt-Ru), platinum iron (Pt-Fe), platinum nickel (Pt-Ni), platinum cobalt (Pt-Co), platinum molybdenum (Pt-Mo), Pt-Ru-Mo, Pt-Ru-Ni, etc., as well as combinations of catalysts.

In general, an electrode can include the electrode active particles 6 in an amount of from about 50 wt. % to about 90 wt. % of the total electrode, such as from about 55 wt. % to about 85 wt. %, or from about 60 wt. % to about 80 wt. %, in some embodiments.

Optionally, an electrode can include one or more additional materials that can improve one or more functions of the electrode. For instance, in some embodiments, an electrode can further include a binder that is not necessarily an ionomer and/or a polymeric material that can be utilized to modify/control a characteristic of the electrode, e.g., a mechanical characteristic such as strength, modulus, etc., and/or a physical characteristic such as hydrophilic/hydrophobic characteristics.

In some embodiments, a binder can be present in the electrode in the form of a particle. For instance, and as illustrated in FIG. 2, an electrode can further include binder particles 12 that can include a binding polymer that is not necessarily an ionomer. In general, the size of binder particles will be less than or equal to the size of the small polymeric particles 4 and sub-micron in size, i.e., having an average size of about 1 micrometer or less. For instance, the small particles 4 can have an average size of from about 10 nanometers to about 1 micrometer, from about 20 nanometers to about 800 nanometers, or from about 100 nanometers to about 500 nanometers, in some embodiments.

In other embodiments, a binder or other polymeric component of an electrode need not be in the form of particles within the electrode. For instance, the binder can be a polymer that is covalently bonded to one or more other components of the electrode. For instance, a polymeric binder can be covalently bonded to one or more of particles 2, particles 4 and/or to the electrode active particles 6.

Binding polymers can include electrode binders as are generally known in the art, examples of which can include, without limitation, polytetrafluoroethylenes (PTFE), carboxymethylcellulose (CMC), rubbers such as styrene butadiene rubber (SBR) and natural latex rubbers, polyacrylic acids (PAA), polyurethanes, ethylene vinyl acetates, polyacrylamides, starches, etc. When present, a binding component can generally be present in an electrode in a relatively small amount, e.g., less than about 5 wt. % of the electrode. For instance, a binder can be present in the electrode in an amount of about 20 wt. % or less, such as from about 2 wt. % to about 15 wt. %, in some embodiments.

To form the electrodes, a slurry including the large polymeric particles 2, the small polymeric particles 4, the electrode active particles 6, and any other optional components, e.g., binder particles 12, in conjunction with a suitable liquid carrier can be formed. The slurry, also referred to as an electrode ink, can have a suitable viscosity for application of the slurry to another electrochemical cell component during formation of the cell. For instance, the solids content of the slurry can be from about 2 wt. % to about 90 wt. % of the slurry, depending upon the application method intended during processing and formation of the electrode, e.g., a lower solids content for a spray application, and a higher solids content for a printing application. The liquid carrier of the ink can be any as is generally known in the art, e.g., water, acetone, 2-propanol, ethanol, or any combination thereof.

In some embodiments, the slurry can include one or more additives that may provide desired functionality to the electrode ink and/or to the formed electrode. When present, an additive may be included in an electrode ink in an amount generally of about 10% or less by weight of the electrode ink. Additives that may be incorporated in an electrode ink can include, without limitation, coupling agents, adhesion promoters, dispersants, curing accelerants, photosensitizers, wetting agents, defoamers, etc. For example, a suitable coupling agent is γ-glycidoxypropyltrimethoxysilane such as Silquest™ A-187, commercially available from Momentive Performance Materials, Albany, NY.

In one embodiment, a wetting agent can be included in the electrode ink. A wetting agent can improve the contact and wetting between the particles, as well as between the particles and a material of the electrochemical cell to which the electrode is applied, e.g., a current collector, a gas diffusion layer, a porous transport layer, etc., onto which the electrode ink can be applied during formation of the cell. A wetting agent can also improve the solubility and dispersibility of the other components of the electrode ink.

Wetting agents can include both sacrificial materials, which will generally be volatized prior to or during drying of the electrode ink, as well as materials that can remain in the electrode following cure. For instance, a wetting agent can also function as an electrolyte following formation of the electrode. Exemplary wetting agents can include, without limitation, acetone, isopropyl alcohol, dimethyl carbonate, and the like. In general, any solvent or electrolyte material that can improve wetting and contact between the components of the electrode ink and a material to which it is applied can be utilized.

The preferred application technique for the electrode ink will generally depend upon the material to which the electrode is to be applied. For instance, fuel cell and electrolyzer electrodes can be fabricated via the catalyst coated membrane (CCM) method in which the electrode ink is sprayed directly onto a PEM. In other embodiments, an electrode ink can be sprayed onto another layer of the cell, e.g., a gas diffusion layer, a current collector, etc. In some embodiments, the electrode ink can be applied to a surface of the cell according to a printing technique (e.g., gravure, flexo, slot die, reverse roll, flat and rotary screen printing, offset, etc.). Of course, other application techniques can be utilized as well (e.g., extrusion, knife over roll, etc.). The deposited mixture is then dried to remove the solvent, optionally under pressure to encourage adhesion between the various components of the electrode. In general, the formed electrode following liquid/solvent removal can have a thickness of from about 1 micrometer to about 500 micrometers, such as from about 5 micrometers to about 250 micrometers, for from about 10 micrometers to about 150 micrometers, in some embodiments.

The formed electrode can be combined with other electrochemical cell components as are known in the art. By way of example, FIG. 3 illustrates one embodiment of an electrochemical cell 20 as may incorporate an electrode as described herein. As illustrated, an electrochemical cell 20 includes a cathode 22 and an anode 24, one or both of which can be electrodes as disclosed herein. The two electrodes are separated by the electrolyte 25, which in this particular embodiment is in the form of a PEM 25.

The electrolyte can encompass any materials and formations as are generally known in the art. When considering a PEM electrochemical cell, the preferred membrane can depend upon the particular application and type of cell. For instance, in those embodiments in which the PEM is designed for transport of protons, e.g., in a hydrogen fuel cell, typical proton-conducting polymer electrolyte membrane materials include PFSA membranes such as those available from DuPont™ Chemicals, Wilmington, Del., under the trade designation Nafion®; from Solvay, Brussels, Belgium, under the trade designation Aquivion®; and from Asahi Glass Co. Ltd., Tokyo, Japan, under the trade designation Flemion™. In some embodiments, a proton-conducting membrane can include a copolymer of tetrafluoroethylene and FSO₂—CF₂CF₂CF₂CF₂—O—CF═CF₂. In those embodiments in which the PEM is designed for transport of anions, e.g., OH⁻, typical anion exchange membrane materials can include functionalized and quaternized poly(norbornenes) such as those sold by Entity FFI IOnix™, Inc. under the trade name Pention™, radiation-grafted polyethylene-based materials (e.g., poly (ethylene-co-tetrafluoroethylene), chloromethylated polysulfones, poly (fluorenyl-co-aryl piperidinium)-based materials, etc.

The electrochemical cell 20 can also include a porous layer 26, 27 adjacent to one or both of the electrodes 22, 24 that can improve contact of the chemical reactants and products with the electrodes 22, 24. For instance, when considering a gaseous reactant or product flow, a porous layer 26 can be a gas diffusion layer. A gas diffusion layer can be fibrous, particulate, or combinations thereof so as to provide uniform distribution of gases at the surface of the electrode and encourage electron transport between the electrode and an external electrical circuit. By way of example, a gas diffusion layer can be formed of carbon fibers, e.g., in a woven or non-woven format.

Porous layers 26, 27 can include a porous transport layer designed to deliver and remove liquid or gas/liquid flows to/from an electrode. In general, a porous transport layer can be formed of sintered metal powders or fibers, metal mesh, or metal foams that can exhibit desirable porosity for fluid flow as well as electron transport capability. The particular metal of choice can depend upon the particular application of the porous transport layer, e.g., anodic or cathodic transport. Non-limiting examples of metals for use in forming a porous transport layer can include, without limitation, titanium, nickel, carbon, stainless steel, copper, etc.

Porous layers 26, 27 can optionally include multiple sub-layers of different porosities, e.g., microporosity, mesoporosity, and/or microporosity, in any desired combination to further refine and define the flow field of the fluid at the electrode and encourage desired interactions between the electrode active materials and the reactants and products of the half-reaction.

An electrochemical cell 20 can also define flow fields 28, 29 at each side of the cell that can deliver and/or remove reactants and products from the cell. For instance, in the illustrated embodiment of FIG. 3, the flow fields 28, 29, are defined by channels formed in bipolar plates 21, 23, respectively. Bipolar plates 21, 23, can be of any design and formation as is generally known in the art so as to provide the desired flow fields 28, 29 generally in conjunction with one or more of electrical connections, temperature control through heat removal, and prevention of leakage external to the cell 20.

While the representative electrochemical cell 20 illustrated in FIG. 3 includes flow into and out of each side of the cell 20, those skilled in the art will understand that in various embodiments, one side or the other of the cell will not require a feed to that side of the cell. Moreover, while illustrated as a PEM electrochemical cell, disclosed electrodes are not limited to such, and may be incorporated in other cell types, such as an alkaline electrolyzer cell described further herein.

A single electrochemical cell 20 can be used alone or combined with other cells to provide a cell stack. A cell stack can include any number of individual electrochemical cell units, for instance, 2 or more, 10 or more, 50 or more, or hundreds of individual cells combined into a single cell stack.

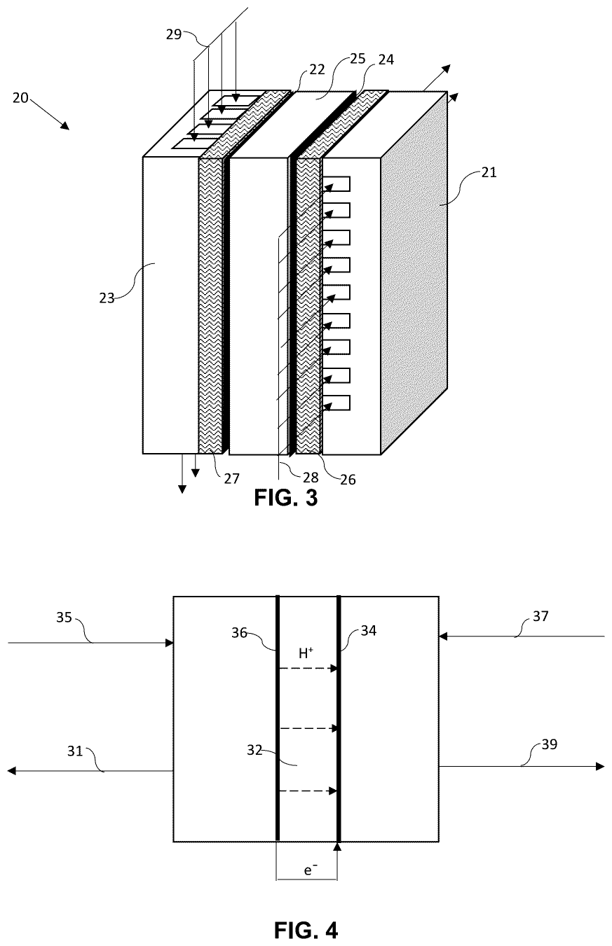

In one embodiment, an electrode can be incorporated into a fuel cell in which the electrochemical cell is designed to utilize electrical energy generated at a cell half-reaction, e.g., a hydrogen fuel cell. Referring to FIG. 4, one embodiment of a hydrogen fuel cell is shown that includes a cathode 34 and an anode 36 separated by a proton-conducting PEM 32. In operation of the fuel cell, hydrogen can be fed 35 to the anode side of the cell and oxygen (e.g., air) 37 can be fed to the cathode side of the cell.

At the anode 36, hydrogen is reacted according to the half reaction:

2H₂→4H⁺+4e⁻

The PEM 32 allows transport of the protons formed at the anode 36 to the cathode 34, and thus, the generated electrons can be utilized as they pass through the circuit from the anode 36 to the cathode 34.

At the cathode 34, the protons, oxygen, and electrons react according to the half reaction:

O₂+4H⁺+4e⁻→2H₂O

The water and any unreacted gas of the input flow 37 is then discharged 39 from the cathode side of the cell and unreacted hydrogen is discharged 31 from the anode side of the cell.

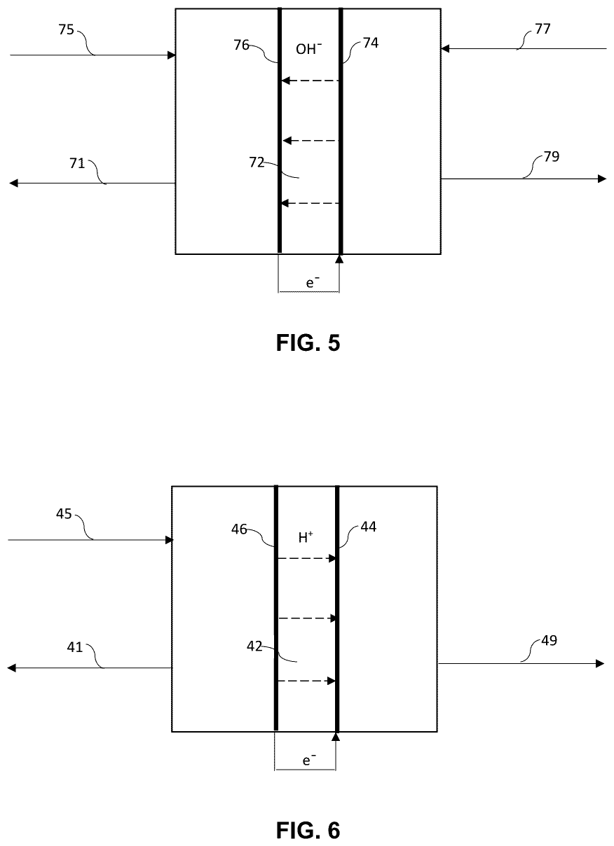

A fuel cell can optionally include an anion exchange membrane. For instance, FIG. 5 illustrates a hydrogen fuel cell that includes a cathode 74 and an anode 76 separated by an anion-conducting PEM 72. In operation of the fuel cell, hydrogen can be fed 75 to the anode side of the cell, and water and oxygen (e.g., air) can be fed 77 to the cathode side of the cell. While illustrated in FIG. 5 with a single feed 77, one of skill in the art will understand that the feed to the cathode can alternatively be provided to the cell in separate oxygen and water feed lines.

At the cathode 74, water, oxygen, and electrons react according to the half reaction:

O₂+2H₂O+4e⁻→4OH⁻

The PEM 72 allows transport of the hydroxide ions formed at the cathode 74 to the anode 76. At the anode 76, hydrogen is reacted with the hydroxide ions according to the half reaction:

2H₂+4OH⁻→4H₂O+4e⁻

And the generated electrons can be utilized as they pass through the circuit from the anode 76 to the cathode 74. Unreacted water and gases of the input flow 77 can be discharged 79 from the cathode side of the cell, and water and unreacted hydrogen can be discharged 71 from the anode side of the cell.

Disclosed electrodes can also be useful in electrolyzers in which electricity is utilized to encourage a chemical reaction. An electrolyzer can be designed to produce hydrogen via water electrolysis, carbon-containing chemicals from carbon dioxide, or other reactions as are known in the art.

Referring to FIG. 6, for instance, one embodiment of a proton exchange PEM water electrolyzer is shown that contains a cathode 44 and an anode 46 separated by a PEM 42. In the illustrated embodiment, water can be fed 45 to the anode side of the electrolyzer cell. In some embodiments, water may be fed to both sides of the cell in order to improve hydration of the PEM 42.

At the anode 46, water is reacted according to the half reaction:

2H₂O→4H⁺+O₂+4e⁻

The PEM 42 allows transport of the protons formed at the anode 46 to the cathode 44.

At the cathode 44, the protons and electrons react according to the half reaction:

4H⁺+4e⁻→2H₂

Oxygen and unreacted water is then discharged 41 from the anode side of the cell, and the hydrogen is then discharged 49 from the cell at the cathode side of the cell. In general, the products can be discharged with water so far as water has been supplied in an amount great enough to purge them from the cell. Thereafter, the oxygen and hydrogen products can be separated from the water, as desired.

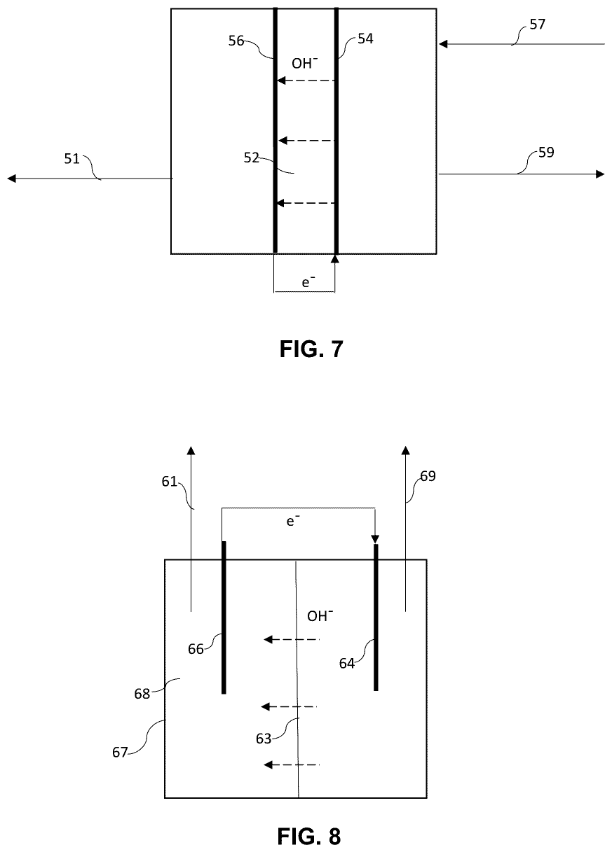

FIG. 7 presents one embodiment of an anion exchange water electrolyzer cell that contains a cathode 54 and an anode 56 separated by an anion exchange membrane 52. In an alkaline water electrolyzer, feed to the cell can include water or water with a suitable alkaline electrolyte (e.g., HCO₃⁻/CO₃²⁻, KOH, etc.). In the illustrated embodiment, an alkaline water composition can be fed 57 to the cathode side of the electrolyzer cell. In other embodiments, the alkaline feed or water can be fed to the anode side of the electrolyzer cell as well, for instance, to improve hydration of the anion exchange PEM 52. In other embodiments, water or the alkaline electrolyte can be fed to both the anode and the cathode.

The half reaction at the cathode 54 is as follows:

4H₂O+4e⁻→2H₂+4OH⁻

The half reaction at the anode 56 is as follows:

4OH⁻→O₂+2H₂O+4e⁻

The anion exchange membrane 52 allows transport of the hydroxide anions formed at the cathode 54 to the anode 56. The oxygen is then discharged from the 51 anode side in conjunction with unreacted water, and the hydrogen is discharged 59 from cathode side of the cell. In general, the products can be discharged with alkaline water feed. The products can then be separated, purified, and collected, as desired.

As stated previously, the electrodes of the present disclosure are not limited to use in PEM electrochemical cells and can be utilized in other types of cells. By way of example, FIG. 8 illustrates one embodiment of an alkaline electrolyzer cell that can incorporate a cathode 64 and an anode 66 held within a tank 67 that contains an aqueous alkaline electrolyte liquid 68. Disclosed electrodes can beneficially be utilized as one or both of the cathode 64 and the anode 66. In general, an electrolyzer cell can include a diaphragm 63 separating the hydrogen and oxygen products from one another and allowing transport of hydroxide ions across the cell, e.g., a composite of zirconia and polysulfones available under the trade designation Zirfon®.

Alkaline electrolytes of a system can include, without limitation, sodium hydroxide, potassium hydroxide, lithium hydroxide, etc.

At the cathode 64, water is reacted according to the half reaction:

4H₂O+4e⁻→2H₂+4OH⁻

The hydroxide ion thus formed at the cathode 64 is transported to the anode 66, where it reacts according to the half reaction:

4OH⁻→O₂+2H₂O+4e⁻

The oxygen can then be collected and discharged 61 from the anode side of the cell, and the hydrogen can likewise be collected and discharged 69 from the cathode side of the cell. In some embodiments, the products can be discharged with an amount of the alkaline electrolyte solution.

While certain embodiments of the disclosed subject matter have been described using specific terms, such description is for illustrative purposes only, and it is to be understood that changes and variations may be made without departing from the spirit or scope of the subject matter.

What is claimed is:

1. An electrode comprising:
first polymeric particles having an average cross-sectional dimension of from about 5 micrometers to about 50 micrometers, the first polymeric particles comprising a first ionomer;
second polymeric particles having an average cross-sectional dimension less than the cross-sectional dimension of the first polymeric particles, the second polymeric particles comprising a second ionomer; and
electrode active particles, wherein the electrode active particles are in ionic communication with the first polymeric particles and the second polymeric particles.

2. The electrode of claim 1, wherein the second polymeric particles have an average cross-sectional dimension of about 1 micrometer or less.

3. The electrode of claim 1, wherein the first ionomer and the second ionomer comprise the same ionomer.

4. The electrode of claim 1, wherein the first ionomer and the second ionomer independently include a backbone comprising one or more of a polyethylene, a polybutylene, a polysulfone, a polyphenylene oxide, a polyphenylene, a polybenzimidazole, a polynorbornene, a polystyrene, a polymethacrylate, a poly(ethylene-co-tetrafluoroethylene), or any combination thereof.

5. The electrode of claim 1, wherein the first ionomer and/or the second ionomer is partially or fully fluorinated.

6. The electrode of claim 1, wherein the ionomer is an anion conductor.

7. The electrode of claim 1, wherein the ionomer is a cation conductor.

8. The electrode of claim 1, wherein the electrode active particles each comprise a plurality of catalyst particles on a carrier particle.

9. The electrode of claim 8, wherein the catalyst particles comprise one or more of Au, Ag, Pd, Pt, Rh, Cu, Fe, Ni, Co, Sn, Ti, In, Al, Ta, Sb, Ru, Mo, and Cr and the carrier particle comprises carbon.

10. The electrode of claim 1, further comprising a binder.

11. The electrode of claim 10, wherein the binder is in the form of binder particles.

12. The electrode of claim 10, wherein the binder is in the form of a binder polymer covalently bonded to one or more of the first polymeric particles, the second polymeric particles, and the electrode active particles.

13. The electrode of claim 10, wherein the binder comprises a polytetrafluoroethylene, a carboxymethylcellulose, a rubber, a polyacrylic acid, a polyurethane, an ethylene vinyl acetate, a polyacrylamide, a starch, or any combination thereof.

14. A method for forming an electrode comprising:
combining first polymeric particles, second polymeric particles, and electrode active particles with a liquid to form a slurry, the first polymeric particles having an average cross-sectional dimension of from about 5 micrometers to about 50 micrometers, the first polymeric particles comprising a first ionomer, the second polymeric particles having an average cross-sectional dimension less than the cross-sectional dimension of the first polymeric particles, the second polymeric particles comprising a second ionomer;
applying the slurry to a surface of an electrochemical cell; and
removing the solvent from the slurry.

15. The method of claim 14, wherein the liquid comprises water, acetone, 2-propanal, or any combination thereof.

16. The method of claim 14, wherein the slurry is applied to a gas diffusion layer or a polymer electrolyte membrane of an electrochemical cell.

17. An electrochemical cell comprising:
a first electrode, the first electrode including
a) first polymeric particles having an average cross-sectional dimension of from about 5 micrometers to about 50 micrometers, the first polymeric particles comprising a first ionomer,
b) second polymeric particles having an average cross-sectional dimension less than the cross-sectional dimension of the first polymeric particles, the second polymeric particles comprising a second ionomer, and
c) first electrode active particles, wherein the first electrode active particles are in ionic communication with the first polymeric particles and the second polymeric particles;
a second electrode; and
an electrolyte, wherein the first electrode and the second electrode are in ionic communication with the electrolyte and are configured for electrical communication with an electric circuit.

18. The electrochemical cell of claim 17, wherein the second electrode includes:
a) third polymeric particles having an average cross-sectional dimension of from about 5 micrometers to about 50 micrometers, the third polymeric particles comprising a third ionomer,
b) fourth polymeric particles having an average cross-sectional dimension less than the cross-sectional dimension of the third polymeric particles, the fourth polymeric particles comprising a fourth ionomer, and
c) second electrode active particles, wherein the electrode active particles are in ionic communication with the third polymeric particles and the fourth polymeric particles.

19. The electrochemical cell of claim 17, wherein the electrolyte is in the form of a proton exchange polymer electrolyte membrane or an anion exchange polymer electrolyte membrane.

20. The electrochemical cell of claim 17, where the cell is a fuel cell.

21. The electrochemical cell of claim 20, wherein the fuel cell is a hydrogen fuel cell.

22. The electrochemical cell of claim 17, wherein the cell is an electrolyzer.

23. The electrochemical cell of claim 22, wherein the electrolyzer is a water electrolyzer.
